(19) United States
(12) Patent Application Publication
(10) Pub. No.: US 2010/0299598 A1
(43) Pub. Date: Nov. 25, 2010

(54) METHOD FOR PROVIDING PAGES AND PORTABLE TERMINAL ADAPTED TO THE METHOD

(75) Inventors: Seung Woo SHIN, Seoul (KR); Bong Won LEE, Seoul (KR); In Won JONG, Seoul (KR); Paihonensami VIKTOR, Kempele (FI)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/776,600

(22) Filed: May 10, 2010

(30) Foreign Application Priority Data
May 19, 2009 (KR) 10-2009-0043440

(51) Int. Cl. G06F 3/048; G06F 3/01

(52) U.S. Cl. 715/702; 715/773; 715/764

(57) ABSTRACT

A method for providing pages and a portable terminal adapted thereto are disclosed. The display unit displays pages belonging to a same category or a different category, according to the generation of different input signals, wherein pages are displayed in accordance with their arrangement within a corresponding category

### CLAIM OF PRIORITY

This application claims, pursuant to 35 USC 119(a), priority to, and the benefit of the earlier filing date of, that patent application filed in the Korean Patent Office, entitled “Method for Providing Pages and Portable Terminal Adapted to the Method, on May 19, 2009 and afforded serial number 10-2009-0043440, the contents of which are incorporated by reference, herein.

### BACKGROUND OF THE INVENTION

1. Field of the Invention

The present invention relates to the field of portable communication devices, and more particularly, to a method replacing a currently displayed page to allow rapid searching

2. Description of the Related Art

Portable terminals refer to devices that can support at least a call function, a message function, and other communication based and non-communication based functions. They are widely applied to various areas due to convenience and easy portability. These portable terminals are equipped with various input systems to provide user functions. For example, the portable terminal may employ a mechanical keypad that allows a user to input numbers or letters. In particular, the portable terminal may be relatively small to achieve portability. In that case, the portable terminal may include of a touch screen as an input system, instead of the keypad, thereby ensuring a relatively large size for the display unit.

Conventional portable terminals have displayed menu formats on the home screen, where the menu formats are supported by the portable terminals or set by a user. The portable terminals directly control functions linked to a particular component contained in a corresponding menu format in order to search other menus. In addition, the portable terminals may set a particular menu to a specific shortcut key, so that the particular menu can be executed via the shortcut key.

In recent years, portable terminals have been developed to provide a plurality of functions and, accordingly, they cannot perform a rapid and correct searching operation via a conventional home screen managing method, thereby inconveniencing users.

### SUMMARY OF THE INVENTION

The present invention provides a method that provides a plurality of pages, distinguished into at least two categories and replaces the pages among the categories according to a particular input signal, so that a user can rapidly search his/her demanded item.

The present invention further provides a portable terminal adapted to the method.

In accordance with an exemplary embodiment of the present invention, the present invention provides a method for providing a plurality of pages classified into N categories (N is an integer, N≦2) in a portable terminal, the method including: displaying a particular page belonging to a K-th category (K is an integer, 1≦K≦N) on a display unit; and displaying, if a particular input signal is generated, a particular page belonging to the K-th category or to a J-th category (J is integers, 1≦J≦N, J≠K) on the display unit.

In accordance with another exemplary embodiment of the present invention, the present invention provides a portable terminal including: a storage unit for storing a plurality of pages classified into N categories (N is an integer, N≧2); a display unit for displaying a particular page belonging to a K-th category (K is an integer, 1≦K≦N); and a controller for replacing the particular page with another page, according to the generation of a particular input signal. The controller displays the other page, belonging to the K-th category if a first input signal is generated, and a particular page, belonging to a J-th category (J is an integer, 1≦J≦N, J≠K), on the display unit.

### BRIEF DESCRIPTION OF THE DRAWINGS

The features and advantages of the present invention will become more apparent from the following detailed description in conjunction with the accompanying drawings, in which:

FIG. 1 shows screens that describe a process for providing pages of a portable terminal according to an embodiment of the present invention;

FIG. 2 shows screens that describe a process for replacing pages in a page array composed of a plurality of pages belonging to a plurality of categories, according to an embodiment of the present invention;

FIG. 3 shows screens that describe a page replacement history process according to an embodiment of the present invention;

FIG. 4 shows screens that describe a page replacement process according to a touch event, according to an embodiment of the present invention;

FIG. 5 is a schematic block diagram illustrating a portable terminal according to an embodiment of the present invention; and

FIG. 6 is a flow chart that describes a method for providing pages, according to an embodiment of the present invention.

### DETAILED DESCRIPTION OF THE INVENTION

Exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

The terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

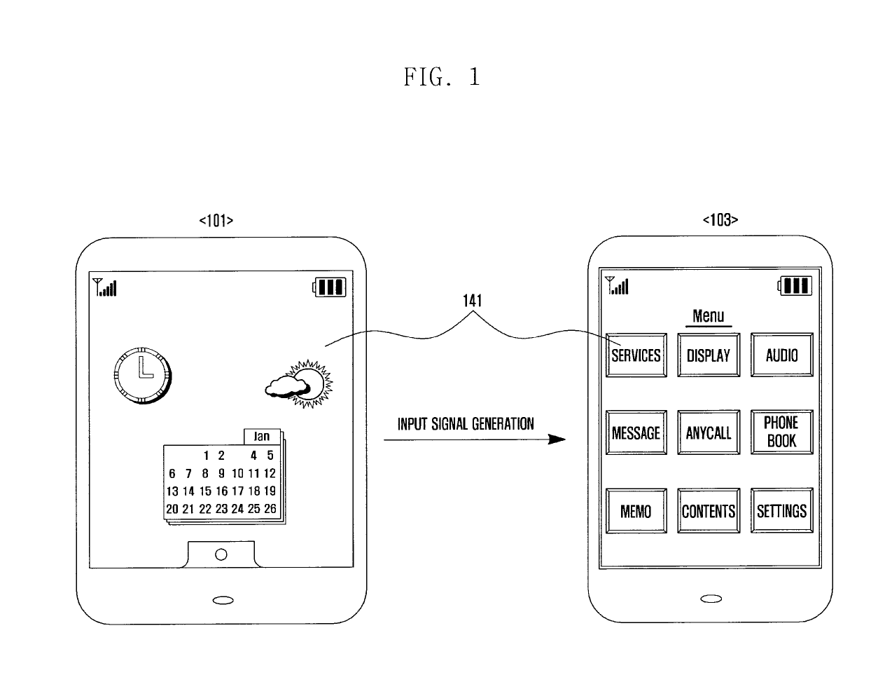

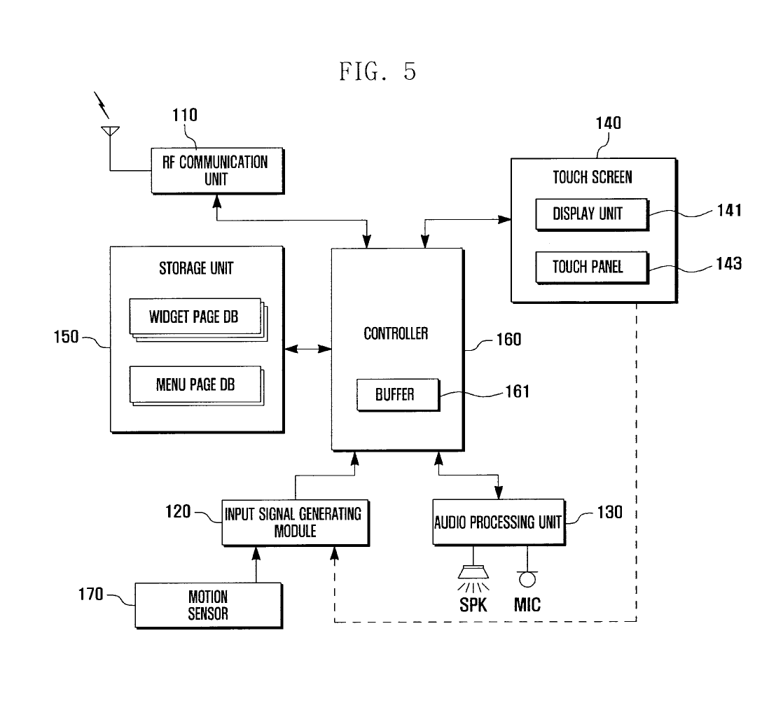

FIG. 1 shows screens that describe a process for providing pages of a portable terminal according to an embodiment of the present invention. The process (method) will be explained based on a portable terminal equipped with a touch screen, where the touch screen includes a display unit 141 (see FIG. 5) displaying a particular screen and a touch panel 143 (See FIG. 5), arrayed on the display unit 141, for detecting a user's touch.

Referring to FIG. 1, when the portable terminal is turned on, its elements are initialized. After that, the portable terminal controls signal flow to operate the touch screen. During this process, the portable terminal displays a preset page as a home screen as shown in view 101 of FIG. 1. The home screen refers to a screen for displaying a preset page after completing the initialization of the terminal. The home screen may correspond to an idle screen. After having performing the initialization, the portable terminal collects information related to a stored page to be output on a home screen and then outputs the collected page on the home screen of the display unit 141. The home screen may be displayed with a particular page according to a designer's purpose. Components may be configured differently in a page to be output on a home screen, according to a user's settings. More specifically, as shown in view 101 of FIG. 1, the portable terminal user sets a plurality of widget icons to be contained in a particular page and sets the particular page with a home screen. In that case, the portable terminal has completed the initialization and then outputs the user's set page as a home screen. The user can group a plurality of widget icons to form a plurality of widget pages according to his/her preference or requirement. In that case, the user sets a particular one from among the plurality of widget pages with a main page as a home screen. That is, the portable terminal can store a plurality of widget pages, recognize a particular one of the plurality of pages as a page for a home screen, according to a user's selected information, and then operate the home screen. When the user generates a particular input signal, for example, a touch movement, sweep, drag, or flick in a first direction, which is called a first touch event, the portable terminal displays another page belonging to the first category, which is the same page as the widget page, where the widget page is a currently output page belonging to the first category.

The particular input signal refers to a request signal to replace one page with another page belonging to the same category. The particular input signal may be generated from a touch event. The particular input signal may also be generated from a particular motion state of the portable terminal or a change in the motions of the portable terminal if the portable terminal includes a sensor. In particular, if the portable terminal includes a keypad, the particular input signal may be generated from the keypad.

When the user generates a particular input signal, for example, a touch movement, sweep, drag, or flick in a second direction, which is called a second touch event, on the screen as shown in view 101 of FIG. 1, the portable terminal displays a particular page belonging to a second category, which differs from the currently displayed page belonging to the first category. That is, as shown in view 103 of FIG. 1, the portable terminal may display a menu page on the home screen. The second category to which the menu page belongs may further contain pages to which other menus are arranged. That is, if the portable terminal provides a number of menus or the user forms a particular page with particular menus by arraying the menus, the second category may contain a plurality of pages. If the user generates the first touch event, the portable terminal can display a different menu page belonging to the second category, which is the same category to which the menu page currently being output on the display unit 141 belongs. If the second touch event has occurred on the screen on which the main page is being displayed, the portable terminal may display a particular page belonging to the first category, i.e., a widget (i.e., an application) page. Alternatively, the portable terminal can display a page belonging to the first category that was being displayed on the display unit 141 before a page belonging to the second category is displayed. To this end, it is preferable that the portable terminal stores information regarding the page replacement order.

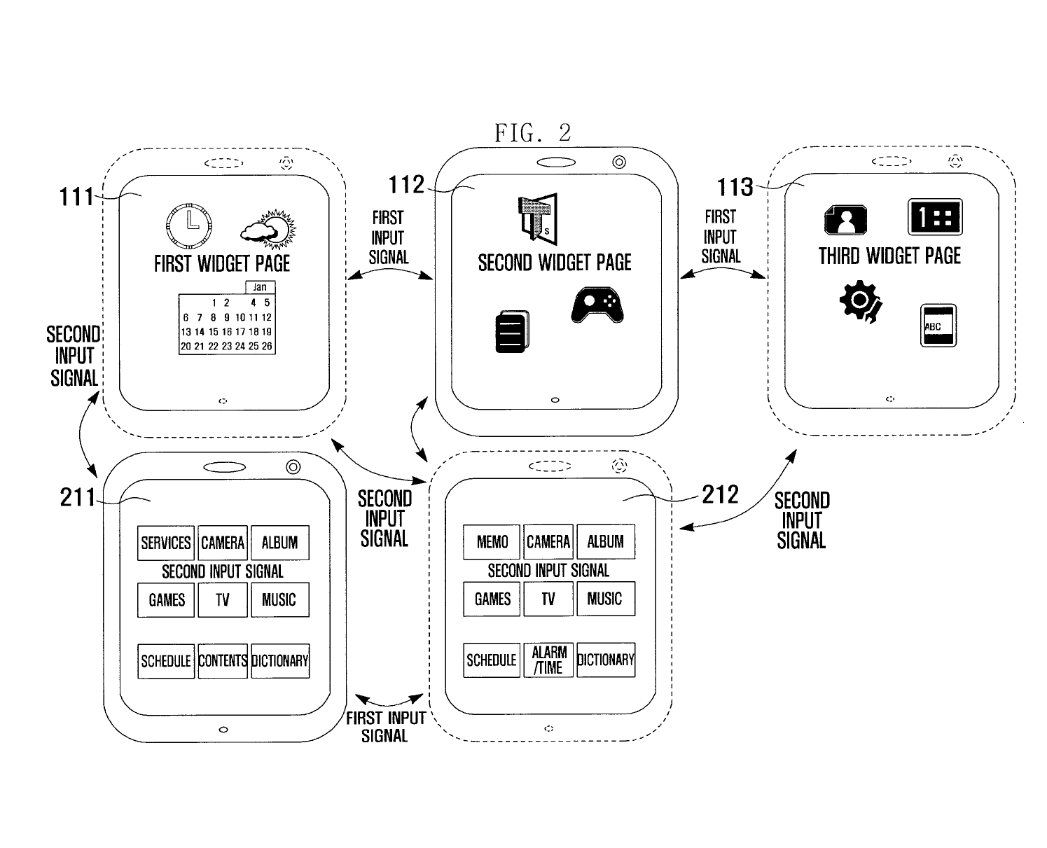

The page replacement is explained in detail with reference to FIG. 2.

FIG. 2 shows screens that describe a method (process) for replacing pages in a page array composed of a plurality of pages that are classified into a plurality of categories, according to an embodiment of the present invention. In an embodiment of the present invention, the first and second categories are explained based on a widget category and a menu category, respectively. It should be understood that the present invention is not limited to this embodiment. That is, it will be appreciated that the categories may relate to a variety of functions provided by the portable terminal. For example, the categories according to the present invention may further include various categories, such as a file category. In addition, it should be understood that the pages according to the present invention are not limited by the number of pages contained in each category in the described embodiments. In the following description, to replace pages among pages belonging to the same category, the portable terminal user generates an input signal, which will be explained based on a touch event. That is, the first and second input signals correspond to the first and second touch events, respectively. It should be, however, understood that the input signal is not generated by only the touch event. That is, the input signal may be one of a number of different types of signals generated by various methods (see FIG. 5).

Referring to FIG. 2, in the exemplary embodiment shown, the portable terminal includes a widget category and a menu category, where the widget category is comprised of first, second and third widget pages 111, 112 and 113 and the menu category is comprised of first and second menu pages 211 and 212.

The first, second and third widget pages 111, 112 and 113 can each output at least one or more widget icons. The widget pages may duplicate and display a part of the widget icons. The widget icons can be removed from each widget page according to a user's settings. The widget icons may be added to each widget page via an edit screen. As would be appreciated the widget icons may be associated with functions that are executed when an indication of function executed is detected (e.g., double tap).

The first and second menu pages 211 and 212 can each output at least one or more menu icons. Like the widget pages, the first and second menu pages 211 and 212 may also duplicate and display a part of the menu icons. The menu icons may be added to or removed from the menu page, according to a user's settings.

If the user generates the first touch event corresponding to an input signal to replace one page with another in the same category while the second widget page 112 is being displayed on the display unit, the portable terminal removes the second widget page 112 from the display unit and displays the first widget page 111 or the third widget page 113 on the display unit. More specifically, if the first touch event is a left direction touch drag event, the portable terminal displays the first widget page 111, which was displayed on the display unit before the occurrence of the touch drag, or which is arranged in front (i.e., in sequential order) of the second widget page 112, on the display unit. Likewise, if the first touch event is a right direction touch drag event, the portable terminal displays the third widget page 113, arranged following the second widget page 112, on the display unit. That is, if a touch drag event or a flick event in the right or left direction has occurred, the portable terminal performs the replacement of pages belonging to the same category and displays the pages on the display unit, such as a preceding or following page, according to the touch direction.

In a second aspect of the invention, when a touch direction to the right is detected, screen 111 is displayed as if screen 112 is dragged from the display and screen 111 is dragged onto the display. Similarly when a left touch direction is detected screen 112 is dragged to the left and removed from the display and screen 113 replaces the removed screen 112.

Although the invention is described with regard to one aspect of the invention, it would be recognized by those skilled in the art that the operation of the invention is similar in the second aspect of the invention without altering the scope of the invention claimed.

If the first touch event has occurred on the display unit on which the first widget page 111 is being displayed, the portable terminal displays the first menu page 211 or the second menu page 212 belonging to a menu category that differs from a widget category that the first widget page 111 belongs to. If the portable terminal does not have a page history and the second touch event occurs on the first widget page 111, the portable terminal removes the first widget page 111 from the display unit and displays the first menu page 211 on the display unit. That is, if the second touch event, for example, an upward or downward touch drag event, has occurred, the portable terminal performs the movement among the categories, i.e., the movement from a widget category to a menu category, and then displays a particular one of the menu pages belonging to the moved menu category.

If the first touch event has occurred on the display unit on which the first menu page 211 is being displayed, the portable terminal removes the first menu page 211 currently being displayed from the display unit and displays another menu page (or second menu page 212) belonging to the same category, i.e., the menu category, on the display unit. If the first touch event has occurred on the second menu page 212, the portable terminal displays another page (or the first menu page 211) belonging to the menu category on the display unit. If the portable terminal has two menu pages, it displays the other menu page irrespective of the direction of the first touch event. That is, if the menu category has two menu pages, the portable terminal replaces the pages via toggling, irrespective of the direction of the first touch event. If the menu category has two or more menu pages, the portable terminal can display corresponding menu pages, sequentially, according to the selection. That is, the portable terminal replaces and displays the menu pages currently being displayed on the display unit, in the preceding or following direction, according to the direction of the first touch event.

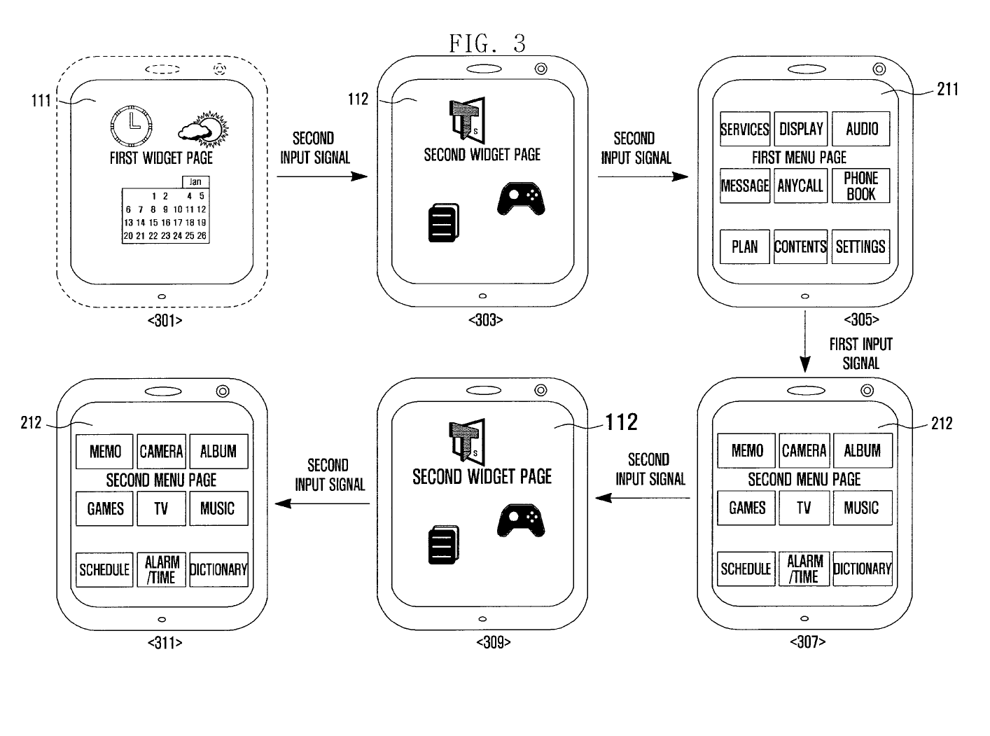

If the second touch has occurred on the display unit on which a particular menu page is being displayed, the portable terminal replaces the particular menu page with a page belonging to a widget category that differs from the menu category. That is, the portable terminal can replace the currently displayed menu page with one from among the first, second and third widget pages 111, 112 and 113 belonging to the widget category. The portable terminal can replace pages among pages in the categories, according to a preset replacement condition. For example, if the page replacement condition is preset in a random way, the portable terminal randomly selects one from among the three widget pages and then displays it on the display unit. If the portable terminal is set to history, it can output the most recently displayed page from the category and displays it on the display unit. This process will be explained in detail with reference to FIG. 3.

As described above, the portable terminal performs the replacement among the categories via toggling, irrespective of the direction of the second touch event, if two menu categories are involved. If the portable terminal needs to add a category, it can display a page belonging to a particular category on the display unit, according to the direction of the second touch event. For example, it is assumed that the portable terminal has three or more categories, such as a widget category, a menu category, and a file category, and a particular menu page belonging to the menu category is currently being displayed on the display unit. If a second touch event has occurred that corresponds to an event where a touch drag or a flick is executed in the upward direction on the display unit, the portable terminal displays a widget page of the pages belonging to the widget category, where the widget page is determined from the pages, to meet a preset condition. Likewise, if a second touch event has occurred that corresponds to an event where a touch drag or a flick is executed in the downward direction on the display unit, the portable terminal displays a widget page of the pages belonging to the file category, where the widget page is determined from the pages, to meet a preset condition.

FIG. 3 shows screens that describe a page replacement history according to an embodiment of the present invention. It is assumed that the pages are classified into two categories, i.e., a widget category and a menu category, where the widget category is composed of first and second widget pages 111 and 112 and the menu category is comprised of first and second menu pages 211 and 212.

Referring to FIG. 3, the portable terminal user performs six page search actions. When a particular input signal is generated in a particular page, the portable terminal can replace the particular page with a page that belongs to the same category that the particular page belongs to or that belongs to a category that differs from the category that the particular page belongs to, according to a particular input signal generated in a particular page. More specifically, when the portable terminal has performed a booting process and its elements have been initialized, the portable terminal displays a page set with a home screen, for example, the first widget page 111 belonging to the first category, on the display unit as shown in view 301 of FIG. 3.

After that, when the user generates a first input signal to search for other widget pages, the portable terminal searches for other widget pages belonging to the same category, according to the first input signal. The portable terminal searches for the second widget page 112 belonging to the first category, removes the first widget page 111 from the display unit, and displays the second widget page 112 on the display unit as shown in view 303 of FIG. 3.

Next, the user can also execute the search of a page belonging to a menu category, for example, the second category. To this end, the user generates a second input signal distinguished from the first input signal. The portable terminal searches for a page belonging to the different category, according to the second input signal. The portable terminal searches for a stored menu category that can be output on the home screen and then displays one of the menu pages belonging to the menu category on the display unit. If the menu category contains a plurality of menu pages, the portable terminal selects one of them according to a preset condition, for example, a random selection or history information, and displays the selected menu page on the display unit. If there is no history information or the first menu page is selected at random, the portable terminal removes the second widget page 112 from the display unit and displays the first menu page 211, as shown in view 305 of FIG. 3.

After that, if the user generates the first input signal again, the portable terminal replaces the first menu page with the second menu page 212 belonging to the menu category, i.e., the second category, according to the first input signal, as shown in view 307 of FIG. 3. If a second input signal is generated while the second menu page 212 is being displayed on the display unit, the portable terminal searches for other stored categories according to the second input signal. If the portable terminal has stored only a widget category as the other categories, it selects the widget category and displays a particular widget page belonging to the menu category on the display unit. As shown in view 309, the portable terminal may display the second widget page 112 on the display unit, where the second widget page 112 belonging to the widget category was displayed before the replacement of pages between the categories is performed. To this end, if pages are replaced between the categories, the portable terminal can store information regarding the page belonging to the preceding category and was displayed on the display unit.

If the user generates the second input signal to request the replacement of pages between the categories while the second widget page 112 is being displayed on the display unit, the portable terminal searches for a page belonging to a menu category that differs from the widget category of the page currently being displayed on the display unit. After that, as shown in view 311 of FIG. 3, the portable terminal displays the second menu page 212 on the display unit, where the second menu page 212 was recently selected from the menu categories before one of the pages belonging to another menu category is replaced based on categories, and displayed on the display unit.

As described above, the first input signal may be a key input signal output from a keypad. The first input signal may also be a sensor-based motion signal output from a motion sensor if the portable terminal includes the motion sensor. The first input signal may also correspond to at least one touch event. That is, at least one touch event is generated by a touch drag motion, a flick motion, etc. For example, the touch drag event is generated as a touch is dragged to the left direction, the right direction, or both directions. The flick event is generated as a flick is performed in the left or right direction. Likewise the first input signal, the second input signal may be a key input signal, a motion signal, a touch event, etc. The second input signal differs from the first input signal. For example, the second input signal may be an upward touch drag event, a downward touch drag event, etc.

Referring to FIG. 3, the method for providing pages, according to an embodiment of the present invention, has been explained in such a way that the replacement of pages is performed, irrespective of the direction of input signals, based on the first and second menu pages and the first and second widget pages. It should be, however, understood that the present invention is not limited to the embodiment. If the portable terminal includes three or more pages in order, it can display a preceding or following page on the display unit, according to an input signal having a direction.

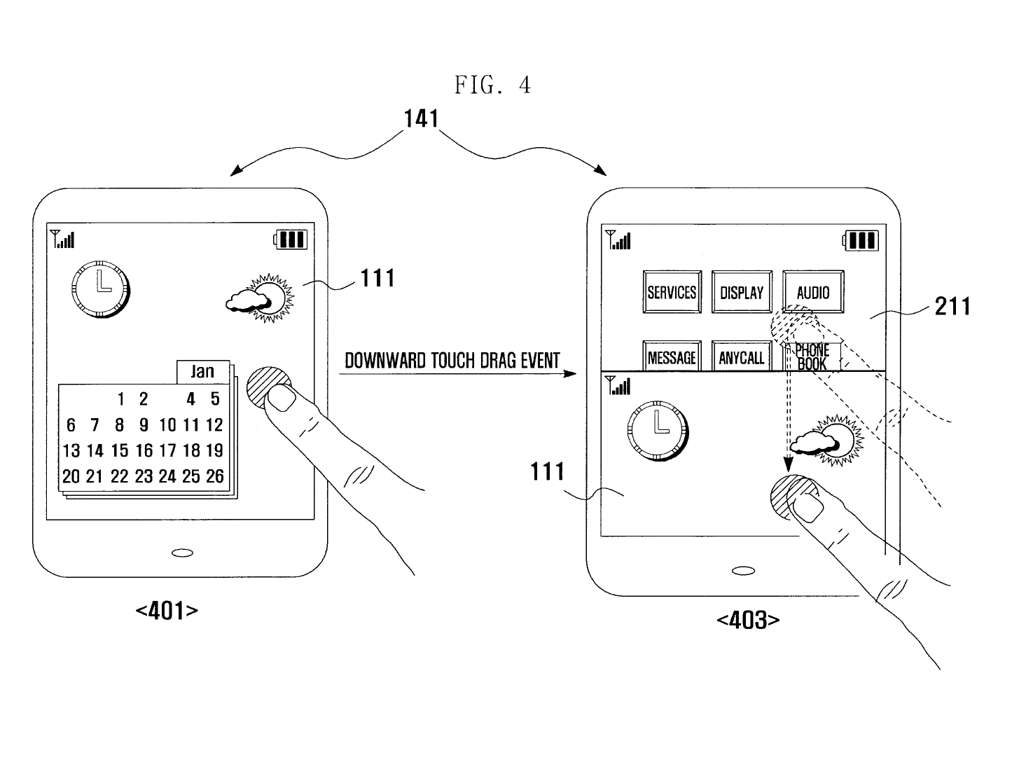

FIG. 4 shows screens that describe a page replacement process according to a touch event, according to an embodiment of the present invention.

As shown in view 401 of FIG. 4, the portable terminal displays a first widget page 111 on the home screen of the display unit 141, according to a user's setting. The portable terminal user can generate a touch event to replace the first widget page 111 with a page contained in another category. That is, the user touches a certain position on the first widget page 111 (a touch down event) and then drags downward (a touch drag event), retaining the touch. In that case, as shown in view 403 of FIG. 4, the portable terminal moves the first widget page 111 to the lower side on the display unit 141, according to the touch drag event. Simultaneously, the portable terminal displays a first menu page 211, which is preset, on the area generated as the first widget page 111 is moved, according to the touch drag event. After that, if the touch drag event is generated at a preset boundary, for example, a certain area of the lower side of the display unit 141, the portable terminal removes the first widget page 111 from the display unit 141 as the touch drag motion is moved, and accordingly displays the first menu page 211 on the entire screen.

If a touch drag event is generated at a certain distance and then released (which is referred to as a touch up event), the portable terminal recognizes that the current page is to be replaced with another page belonging to another category, and then displays a first menu page. In this process, the portable terminal can move the first widget page 111 on the screen, in response to the movement distance of the touch drag event. If a touch drag event is generated beyond the boundary and then a touch up event is generated, the portable terminal removes the page that is being moved according to the touch drag event from the display unit and displays a page belonging to the other category.

As described above, although the embodiment has been explained in such a way that the touch drag is generated in a downward direction, it should be understood that the present invention is not limited to the embodiment. That is, the portable terminal can display a page belonging to another category according to a touch drag that is generated in an upward direction. In addition, if the portable terminal includes three or more categories in order, it can display a particular page belonging to the preceding or following category, with respect to the page currently displayed on the display unit, according to the direction of the touch drag event.

In the foregoing description, a screen interface for providing pages, according to an embodiment of the present invention, has been explained. The following description provides the configuration of the portable terminal that supports the screen interface with reference to FIG. 5.

FIG. 5 is a schematic block diagram illustrating a portable terminal according to an embodiment of the present invention.

Referring to FIG. 5 the portable terminal includes an RF communication unit 110, an input signal generating module 120, an audio processing unit 130, a touch screen 140, a storage unit 150, and a controller 160.

The portable terminal displays another page belonging to a category that is the same category of the currently displayed page when a first input signal is generated. The portable terminal also displays a page belonging to a category that differs from the category that the currently displayed page belongs to when a second input signal is generated.

In the following description, each element of the portable terminal is explained in detail.

The RF communication unit 110 establishes communication channels for performing a voice call and for transmitting data, such as images, etc., under the control of the controller 160. That is, the RF communication unit 110 may establish a voice call channel, a data communication channel, and/or a video call channel among mobile communication systems. To this end, the RF communication unit 110 includes an RF transmitter for up-converting the frequency of signals to be transmitted and amplifying the to-be transmitted signals and an RF receiver for low-noise amplifying received RF signals and down-converting the frequency of the received RF signals. The RF communication unit 110 can be selected under the control of the controller 160, according to a touch event that occurred in the touch panel 143. In particular, the RF communication unit 110 can be operated as a variety of icons related to a communication function are activated. That is, the RF communication unit 110 can be activated icons contained in a variety of pages displayed on the home screen, for example, a widget icon or a menu icon. For example, if a widget icon is activated that serves to receive information from an Internet server, the RF communication unit 110 may be activated to establish a communication channel with the Internet server. Likewise, if a menu icon is activated that serves to make a call or transmit a message based on a mobile communication system, the RF communication unit 110 establishes a communication channel with the mobile communication system. In that case, the portable terminal displays a screen necessary for a user function, for example, a phonebook screen, a message writing screen, an email writing screen, a call screen, etc.

The input signal generating unit 120 is composed of a plurality of input keys and function keys (not shown) to receive numerical or alphabetical information and to set a variety of functions. The function keys include direction keys, side keys, shortcut keys, etc., which are set to perform specific functions. The input signal generating unit 120 generates key input signals related to a user's settings and the function control of the portable terminal and transmits them to the controller 160. The input signal generating unit 120 may be implemented with a QWERTY keypad, 3×4 keypad, 4×3 keypad, etc. The input signal generating unit 120 may be omitted if the portable terminal is equipped with the touch screen 140 as a full screen. The input signal generating unit 120 may include at least one sensor (motion sensor 170) for generating a particular signal according to a motion state of the portable terminal. In an embodiment of the present invention, the sensor includes a tilting sensor, an acceleration sensor, a gyro sensor, etc. The sensors generate a motion signal by sensing the motion of the portable terminal and transmit it to the controller 160.

The audio processing unit 130 includes a speaker SPK for reproducing audio data received and transmitted during a voice call and a microphone MIC for receiving a user's voice during the voice call or other audio signals. The audio processing unit 130 can output an audio signal notifying the user of the page change or the page replacement in the screen interfaces as described above. For example, the audio processing unit 130 can output different effect sounds according to whether pages are replaced with the pages that belong to the same category or to the different categories, under the control of the controller 160.

The touch screen 140 includes a display unit 141 and a touch panel 143. The touch screen 140 may be configured in such a way that the touch panel 143 is mounted on in front of the display unit 141. The size of the touch panel 143 determines the size of the touch screen 140.

The display unit 141 displays a variety of menus of the portable terminal and information input or provided by or to a user. That is, the display unit 141 can provide a variety of screens, for example an idle screen, a menu screen, a message writing screen, a call screen, etc., as previously illustrated.

In an embodiment of the present invention, the display unit 141 can display a particular page on the home screen, according to a user's settings or a designer's purpose. The particular page may belong to one among a widget category, a menu category, a file category, etc. When the controller 160 receives an input signal for requesting the page replacement, the display unit 141 replaces a currently displayed page with another page belonging to a category that is the same category as that the currently displayed page or with a page belonging to a category that differs from the category that the currently displayed page belongs to, and removes the currently displayed page. Since the page replacement has already been explained above, further explanation of its operation need not be discussed. The display unit 141 may be implemented with a liquid crystal display (LCD), an organic light emitted diode (OLED), etc. The display unit 141 is smaller than the touch panel 143 and arranged under the touch panel 143.

The touch panel 143 is configured to cover the display unit 141. When an object contacts or approaches the touch panel 143, the touch panel 143 generates a touch event and transmits it to the controller 160. The touch panel 143 further includes sensors arrayed in the matrix form. The touch panel 143 acquires information regarding a position where a touch event has occurred and information regarding the type of the touch event and transmits it to the controller 160. Examples of the type of touch event are a touch down event that occurs when an object contacts the touch panel, a touch up event that occurs when a touched object is removed from the touch panel, a touch movement event, a sweep event or a touch drag event that are generated when an object is moved in a certain direction on the touch panel, retaining the contact, a flick event that occurs when an object contacts and flicks in a certain direction on the touch panel, etc. The touch events are distinguished if they have different directions. That is, if touch and drag motions are executed in the left and right directions, the touch events corresponding to the motions are recognized as different input signals.

The storage unit 150 stores application programs required to operate functions according to an embodiment of the present invention. If the portable terminal is equipped with a touch screen, the storage unit stores a key map or a menu map, etc., for operating the touch screen. The key map and the menu map can be implemented in various forms. For example, the key map may be a keyboard map, a 3×4 key map, a QWERTY key map, etc. In particular, the key map may be a control key map for controlling an application program being currently activated. The menu map may be implemented with a menu map for controlling an application program currently being activated or a menu map comprised of various menu items provided by the portable terminal. The storage unit 150 is configured to include a program storing area and a data storing area, which are well-known and need not be shown in detail, herein.

The program storing area stores an operation system (OS) for booting the portable terminal and operating the elements included in the portable terminal. The program storing area also stores various application programs according to the types of portable terminals, examples of which are as follows: an application program for supporting a call function, a web browser for accessing the Internet, an MP3 application program for reproducing audio sources, an image output application program for displaying images, pictures, etc., an application program for reproducing a moving image, etc. In an embodiment of the present invention, the program storing area further stores a touch operating program for supporting a touch function. The touch operating program contains a routine that transmits a type of touch event and information regarding a position where the touch event occurs to the controller. The program storing area also stores a control routine that performs the page replacement on the display unit when a touch event has occurred.

The data storing area stores data generated when the portable terminal is operated. The data storing area also stores a widget data base (DB) and a menu page DB. The widget DB contains phone book information, a variety of menu icons corresponding menus, at least one widget icon according to the widget function, various contents, icons corresponding to the contents, and at least one widget page on which at least one widget icon is arranged. The menu page DB contains at least one menu page on which at least one menu icon is arranged. If the portable terminal is equipped with a touch screen 140, the data storing area stores user's input therefrom. In an embodiment of the present invention, if the page replacement is performed according to a particular input signal that is generated while a particular page is being displayed. The data storing area can then store information regarding the replacement page. That is, the data storing area stores: information regarding another page that belongs to the same category, to which the currently displayed page belongs, and that replaces the currently displayed page, when a first input signal is generated. The data storing area also stores information regarding a particular page that belongs to a category different from the category to which the currently displayed page belongs, and that replaces the currently displayed page, when a second input signal is generated. The data storing area can output the information to controller 160. The data storing area stores a history regarding the page replacement process under the control of the controller. When the category replacement is performed, the data storing area provides information regarding a page belonging to another category, which was recently output on the display unit, to the controller 160.

The controller 160 controls the elements of the portable terminal so that they can, in one aspect, perform an initializing process. After that, the controller controls signal flow among the elements to provide a page replacement function, as described herein. When a first input signal is generated while a particular page is being displayed on the display unit 141, the controller 160 refers to the information stored in the data storing area and controls the display unit 141 to display another page belonging to the same category that the currently displayed particular page belongs to. Likewise, when a second input signal is generated, the controller 160 refers to the information stored in the data storing area and controls the display unit 141 to display a page belonging to a category different from the category that the currently displayed page belongs to. In addition, the controller 160 can manage a history regarding the page replacement and controls the display unit 141 to display a particular page when a category is replaced, where the particular page is one from among pages belonging to another category, which were displayed on the display unit 141 and is displayed immediately before the category replacement. As would be appreciated, the touch panel 143 may logically be represented as a unit of the input signal generator 120. Hence, the inputs from the touch panel 143 are shown dashed to the input signal generating module.

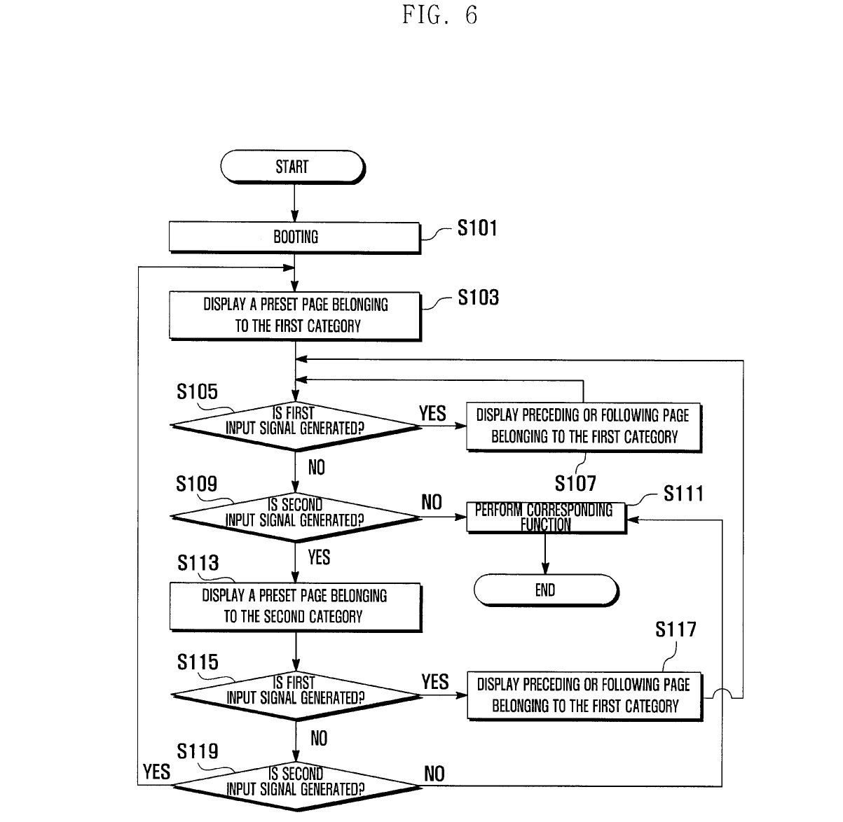

FIG. 6 is a flow chart that describes a method for providing pages, according to an embodiment of the present invention. In an embodiment of the present invention, the pages are classified into two categories. It should be understood that the present invention is not limited to the described embodiment and that the pages may be classified into three or more categories without altering of expanding the scope of the invention described herein.

Referring to FIG. 6, when the portable terminal is turned on, it performs a booting process and initializes its elements (S101). After that, the portable terminal controls the display unit to display a page contained in a preset category, for example, a first category (S103). Alternatively, the portable terminal may be set to control the display unit to display the page when it is activated from a sleep state. The portable terminal is operated in a sleep mode (or a sleep state) if has not been used for a preset period of time. The portable terminal may also be set, according to a user's setting, to activate the touch panel when the display unit is activated, so that the touch panel can detect a user's touch.

When a user generates an input signal via the input signal generating module or the touch screen, for example, the portable terminal determines whether the input signal corresponds to a first input signal (S105). If the portable terminal ascertains that the input signal corresponds to a first input signal at S105, it controls the display unit to display a preceding or following page, with respect to the currently displayed page, if the first category contains three or more pages in order (S107). If the first category contains two or less than two pages at S105, it replaces the pages by toggling and displays the toggled page.

On the contrary, if the portable terminal ascertains that the input signal does not correspond to a first input signal at S105, it determines whether the input signal corresponds to a second input signal (S109). If the portable terminal ascertains that the input signal does not correspond to a second input signal at S109, it performs a corresponding function, such as a message writing, camera, broadcast receiving, voice calling functions, etc. (S111).

If the portable terminal ascertains that the input signal corresponds to a second input signal at S109, it displays a page belonging to a second category (S113). When the portable terminal receives a request to display a page belonging to a corresponding category, it displays one page randomly selected from the pages belonging to the second category, a preset page as a default page, or a page from among the pages belonging to a category where a history has been maintained and then a recently outputted page is output on the display unit.

When the portable terminal receives an input signal via the input signal generating module or the touch panel, it determines whether the input signal corresponds to a first input signal (S115). If the portable terminal ascertains that the input signal corresponds to a first input signal at S115, it displays a following or preceding page that belonging to the second category (S117). As described at S107, if the second category contains three or more pages in order, the portable terminal can replace pages among the following page or preceding page. If the second category contains two or less than two pages, it can replace the pages via toggling. If the second category contains only one page, it does not perform a page replacement and displays a message showing that there is no additional page.

On the contrary, if the portable terminal ascertains that the input signal does not correspond to a first input signal at S115, it further determines whether the input signal corresponds to a second input signal (S119). If the portable terminal ascertains that the input signal does not correspond to a second input signal at S119, it returns to and proceeds with S111. On the contrary, if the portable terminal ascertains that the input signal corresponds to a second input signal at S119, it returns to and proceeds with S103.

As described above, the method for providing pages, according to the present invention, can replace a currently displayed page with another page belonging to a category that is the same category that the currently displayed page belongs to or with a page belonging to a category that differs from the category that the currently displayed page belongs to, according to a particular input signal, thereby allowing a user to easily and rapidly search for a corresponding page.

As described above, according to the method for providing a plurality of pages classified into N categories (N is an integer, N≧2), when a particular page belonging to a K-th category (K is an integer, 1≦K≦N) is displayed on a display unit, a particular page belonging to the K-th category or to a J-th category (J is an integer, 1≦J≦N, J≠K) can be displayed on the display unit, according to a particular input signal, for example a first or second touch event. In order to display a page belonging to the same category, if the K-th category or the J-th category contains one page, the portable terminal outputs a message notifying a user that there are no additional pages, without performing a page replacement. If the K-th category or the J-th category contains two pages, the controller replaces the two pages via toggling, according to the first touch event and displays the toggled page. If the K-th category or the J-th category contains three or more pages in order, the controller displays a preceding or following page on the display unit, with respect to a currently displayed page, according to the direction of the first touch event. In order to display a page belonging to the other categories, if N is equal to or greater than 3 and the categories are arranged in order, the portable terminal displays a particular page belonging to the K−1-th or K+1-th category, with respect to the K-th category to which a currently displayed page belongs, according to the direction of the second touch event. In addition, the portable terminal displays one page among the pages belonging to another category, which has a history where the one page was recently displayed on the display unit before a particular page belonging to the K-th category is displayed, according to the occurrence of the second touch event. The first touch event is one from among a left direction touch drag event, a right direction touch drag event, a left direction flick event, and a right direction flick event.

The second touch event is one from among the following: an upward direction touch drag event is generated as a touch that is dragged in the upward direction to a boundary of the display unit; a touch up event generated as a touch is dragged for a distance in the upward direction and then released from the display unit and a downward direction touch drag event is generated as a touch is dragged in the downward direction by a boundary of the display unit; a touch up event generated as a touch is dragged for a distance in the downward direction and then released from the display unit and; an upward direction flick event is generated as a touch that is flicked in the upward direction on the display unit; and a downward direction flick event is generated as a touch that is flicked in the downward direction on the display unit. It will be appreciated that the directions of the touch events may be defined as opposite to those described above. That is, the first touch event may be generated by the upward and downward motion and the second event by left and right motion.

The above-described methods according to the present invention, under the control of the controller, can be realized in hardware or as software or computer code that can be stored in a recording medium such as a CD ROM, an RAM, a floppy disk, a hard disk, or a magneto-optical disk or downloaded over a network (i.e., The computer program can be provided from an external source which is electronically downloaded over a network, e.g., Internet, POTS, so that the methods described herein can be rendered in such software using a general purpose computer, or a special processor or in programmable or dedicated hardware, such as an ASIC or FPGA. As would be understood in the art, the controller, the computer, the processor or the programmable hardware include memory components, e.g., RAM, ROM, Flash, etc. that may store or receive software or computer code that when accessed and executed by the controller, computer, processor or hardware implement the processing methods described herein. The code when loaded into a general purpose computer transformed the general purpose computer into a special purpose computer that may in part be dedicated to the processing shown herein. In addition, the computer, processor or dedicated hardware may be composed of at least one of a single processor, a multi-processor, and a multi-core processor.

As describe above, the page providing method and the portable terminal adapted thereto, according to the present invention, can rapidly search a page to which a user's required item is set, and allow the user to easily acquire his/her required information via the searched page.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method, operable in a controller, for providing a plurality of pages classified into N categories (N being an integer, N≧2) in a portable terminal, the method comprising:
displaying a particular page belonging to a K-th category (K being an integer, 1≦K≦N) on a display unit; and
displaying, if a particular input signal is generated, one of the particular page belonging to the K-th category and to a J-th category (J being an integer, 1≧J≦N, J≠K) on the display unit.

2. The method of claim 1, further comprising:
displaying, if a first touch event has occurred, another page belonging to the K-th category on the display unit; and
displaying, if a second touch event has occurred, a particular page belonging to the J-th category on the display unit.

3. The method of claim 2, wherein displaying a particular page belonging to the J-th category comprises one of:
outputting, if the K-th category contains one page, a message notifying a user that there is no additional page, without performing a page replacement;
replacing, if the K-th category contains two pages, the currently displayed page with the other page s via toggling, according to the first touch event, and displaying the toggled page; and
displaying on the display unit, if the K-th category contains three or more pages in an order, one of: a preceding and following page, with respect to a currently displayed page, according to a direction of the first touch event.

4. The method of claim 3, wherein the first touch event is one of group consisting of: a left direction touch drag event, a right direction touch drag event, a left direction flick event, and a right direction flick event.

5. The method of claim 2, wherein displaying a particular page belonging to the J-th category comprises:
displaying, if N is equal to or greater than 3 and the categories are arranged in an order, a particular page belonging to the K−1-th or K+1-th category, with respect to the K-th category to which a currently displayed page belongs, according to the direction of the second touch event.

6. The method of claim 2, wherein displaying a particular page belonging to the J-th category comprises:
displaying one page among the pages belonging to another category, wherein the one page was recently displayed on the display unit before a particular page belonging to another category is displayed, according to the occurrence of the second touch event.

7. The method of claim 5, wherein the second touch event is one of:
an upward direction touch drag event generated as a touch dragged in the upward direction to a boundary of the display unit;
a touch up event generated as a touch dragged a distance in the upward direction and then released from the display unit;
a downward direction touch drag event generated as a touch dragged in a downward direction to a boundary of the display unit;
a touch up event generated as a touch dragged by a distance in the downward direction and then released from the display unit;
an upward direction flick event that is generated as a touch flicked in the upward direction on the display unit; and
a downward direction flick event that is generated as a touch flicked in the downward direction on the display unit.

8. The method of claim 6, wherein the second touch event is one of:
an upward direction touch drag event generated as a touch dragged in an upward direction to a boundary of the display unit;
a touch up event generated as a touch dragged a distance in the upward direction and then released from the display unit;
a downward direction touch drag event generated as a touch dragged in a downward direction to a boundary of the display unit;
a touch up event generated as a touch dragged a distance in the downward direction and then released from the display unit;
an upward direction flick event that is generated as a touch flicked in the upward direction on the display unit; and
a downward direction flick event that is generated as a touch flicked in the downward direction on the display unit.

9. The method of claim 1, wherein the particular input signal comprises at least one of:
a key input signal output from a keypad; and
an operation signal generated as a sensor detects at least one from among a motion state and a state change of the portable terminal.

10. A portable terminal comprising:
a storage unit for storing a plurality of pages classified into N categories (N being an integer, N≧2);
a display unit for displaying a particular page belonging to a K-th category (K being an integer, 1≦K≦N); and
a controller, containing a processor, for replacing the particular page with another page, according to generation of a particular input signal,
wherein the controller displays, on the display unit, one of: the other page, belonging to a K-th category if the particular input signal represents a first input signal, and a particular page belonging to a J-th category (J being an integer, 1≦J≦N, J≠K).

11. The portable terminal of claim 10, wherein, if one of the K-th category and the J-th category contains one page, the controller outputs a message notifying a user that there is no additional page if the first input signal is generated, without performing a page replacement.

12. The portable terminal of claim 10, wherein, if one of the K-th category and the J-th category contain two pages, the controller replaces the currently displayed page with a second page via toggling, according to the first input signal, and displays the toggled page.

13. The portable terminal of claim 10, wherein, if one of the K-th category and the J-th category contains three or more pages in an order, the controller displays one of a preceding and a following page on the display unit, with respect to a currently displayed page, according to a direction of the first input signal.

14. The portable terminal of claim 11, wherein the first input signal is one of group consisting of: a left direction touch drag event, a right direction touch drag event, a left direction flick event, and a right direction flick event.

15. The portable terminal of claim 10, wherein, if N is equal to or greater than 3 and the categories are arranged in an order, the controller displays a particular page belonging to the K−1-th or K+1-th category, with respect to the K-th category to which a currently displayed page belongs, according to the direction of the second touch event.

16. The portable terminal of claim 10, wherein the controller displays one page among the pages belonging to the J-th category, which has a history of being the one page recently displayed on the display, according to the occurrence of the second touch event, when a particular page belonging to the J-th category is displayed.

17. The portable terminal of claim 15, wherein the second input signal is one from among the following:
an upward direction touch drag event generated as a touch dragged in an upward direction to a boundary of the display unit;
a touch up event generated as a touch dragged a distance in the upward direction and then released from the display unit;
a downward direction touch drag event generated as a touch dragged in a downward direction by a boundary of the display unit;
a touch up event generated as a touch is dragged a distance in the downward direction and then released from the display unit;
an upward direction flick event that is generated as a touch flicked in the upward direction on the display unit; and
a downward direction flick event that is generated as a touch flicked in the downward direction on the display unit.

18. The portable terminal of claim 16, wherein the second input signal is one of:
an upward direction touch drag event generated as a touch dragged in an upward direction to a boundary of the display unit;
a touch up event generated as a touch dragged a distance in the upward direction and then released from the display unit;
a downward direction touch drag event generated as a touch dragged in a downward direction to a boundary of the display unit;
a touch up event generated as a touch dragged a distance in the downward direction and then released from the display unit;
an upward direction flick event that is generated as a touch flicked in the upward direction on the display unit; and
a downward direction flick event that is generated as a touch flicked in the downward direction on the display unit.

19. The portable terminal of claim 10, further comprising:
an input signal generating module,
wherein the input signal generating module comprises at least one of:
a touch panel for generating an input signal according to a user's touch:
a keypad for generating a key input signal; and
a sensor for detecting at least one from among a motion state and state change of the portable terminal.
